(19) United States
(12) Patent Application Publication
(10) Pub. No.: US 2025/0085028 A1
(43) Pub. Date: Mar. 13, 2025

(54) HEIGHT-ADJUSTABLE MOUNTING SYSTEM

(71) Applicant: Unirac, Inc., Albuquerque, NM (US)

(72) Inventors: Tarun Kumar Polanky, Hyderabad (IN); Todd Ganshaw, Albuquerque, NM (US); Sindhu Madhavi Gopalam, Hyderabad (IN)

(21) Appl. No.: 18/826,535

(22) Filed: Sep. 6, 2024

Related U.S. Application Data
(60) Provisional application No. 63/537,110, filed on Sep. 7, 2023.

(51) Int. Cl. F24S 25/60; H02S 20/30

(52) U.S. Cl. CPC F24S 25/60; H02S 20/30; F24S 2025/6003

(57) ABSTRACT

A mounting system includes a strut channel, a holder clamp configured to connect with the strut channel, and a support clamp configured to secure the holder clamp. The holder clamp is movable in a vertical direction within the support clamp.

### RELATED PATENT APPLICATION

This application claims priority to and the benefit of U.S. Provisional Patent Application No. 63/537,110 filed on Sep. 7, 2023, entitled “Mounting Assembly of a Height Adjustable Attachment Clamp,” and incorporates the content thereof in its entirety by reference.

### BACKGROUND

In the field of solar energy, the installation of a solar panel array system on various roof types presents numerous challenges, particularly when dealing with “flat” roofs where surface irregularities, such as undulations, are common. Solar panel systems must be securely mounted to withstand environmental factors such as wind uplift and to ensure optimal performance and longevity. Existing mounting systems often struggle to address these issues, especially in situations where the roof surface exhibits significant undulations or variations in height.

Conventional mounting solutions such as ballast trays are sometimes insufficient when uplift forces are excessive. Therefore, there is a demand for a height-adjustable mounting system that offers a robust and adaptable solution for mounting the solar panel array system on flat roofs.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1A illustrates a front view of an example mounting system for mounting solar panel array system, according to the embodiments of this disclosure.

FIG. 1B illustrates a side view of the example mounting system for mounting solar panel array system, according to the embodiments of this disclosure.

FIG. 2 illustrates a perspective view of the holder clamp depicted in FIGS. 1A and 1B, according to the embodiments of this disclosure.

FIG. 3 illustrates a perspective view of the support clamp depicted in FIGS. 1A and 1B, according to the embodiments of this disclosure.

FIG. 4 illustrates a perspective view of a strut channel depicted in FIGS. 1A and 1B, according to the embodiments of this disclosure.

FIG. 5A illustrates a perspective view of an example solar panel array system installed onto the mounting system, according to the embodiments of this disclosure.

FIG. 5B illustrates a partial, cut-away view of an example mounting system and a rail/frame of a solar panel module, according to the embodiments of this disclosure.

### DETAILED DESCRIPTION

This disclosure relates to a height-adjustable mounting system that is adaptable and facilitates installation. In an embodiment, a mounting system may include a strut channel, a holder clamp, and a support clamp. The strut channel may be paired with a solar panel array system. The holder clamp may pair with the strut channel, and the support clamp may adjustably connect with the holder clamp to assist with positioning and alignment.

In an embodiment, the mounting system may further include a base that is fixable to a surface. The holder clamp and support clamp may be connected using one or more adjustment fasteners, which facilitate adjustable connections. The holder clamp may include sidewalls with openings and internal passages to accommodate these fasteners to provide flexibility in height adjustment.

In an embodiment, both the holder clamp and support clamp may incorporate serrations on external and/or internal surfaces, respectively. Serrations may enhance friction and stability by preventing slippage between the components, thus maintaining a secure engagement even under varying loads and conditions. Examples of serration shapes include V-shaped, U-shaped, and sawtooth profiles.

In an embodiment, the support clamp may have a slot configured to accommodate part of the holder clamp. This slot mechanism may allow for both positional and orientational adjustments of the holder clamp to provide flexibility in how the solar panel array system may be mounted and aligned.

In an embodiment, the holder clamp and support clamp may be pre-assembled into a clamp assembly. This configuration may simplify installation by reducing the number of separate components and streamlining the assembly process.

As discussed herein, solar panel array systems may be secured via a height-adjustable mounting system to flat surfaces with height variations and/or surface irregularities. In an embodiment, the mounting system accommodates roof undulations, with a precision adjustment range spanning, for example, from −0.25 inches to +2.25 inches. This adjustability may help align and stabilize the solar array system. Furthermore, the mounting system may be compatible with a wide variety of existing flat roof attachment solutions, thereby enhancing the adaptability across various installation scenarios. The mounting system may also integrate with custom or widely used solar panel arrays, offering flexibility for installers and reducing the need for specialized components.

The mounting system described herein may be stable under extreme environmental conditions such as high winds or heavy snow loads. In an embodiment, the mounting system may use a single attachment per module, even when uplift forces exceed traditional ballast tray capacities, to assist in providing structural integrity of the solar array.

Moreover, the mounting system described herein may facilitate an efficient installation process. The preassembly of the holder clamp (e.g., H-shaped component) with the support clamp (e.g., U-shaped component) using height adjustment fasteners may improve installation efficiency and may reduce the need for additional manual effort and tools. Moreover, the installation process may save time and may reduce labor costs.

Furthermore, the disclosed mounting system is adjustable. The asymmetric geometry in the holder clamp allows for enhanced height adjustability beyond the length of the slot in the support clamp. By rotating the holder clamp within the support clamp, the cross-member element may be positioned at varying heights and orientations, extending the effective adjustment range of the slot. Such a configuration provides flexibility in accommodating different roof heights and surface conditions to support optimal alignment and installation across a variety of environments.

Additionally, the mounting system described herein may be cost-effective. The ability to accommodate roof undulations with a precision range of −0.25 inches to +2.25 inches may assist in providing a secure fit.

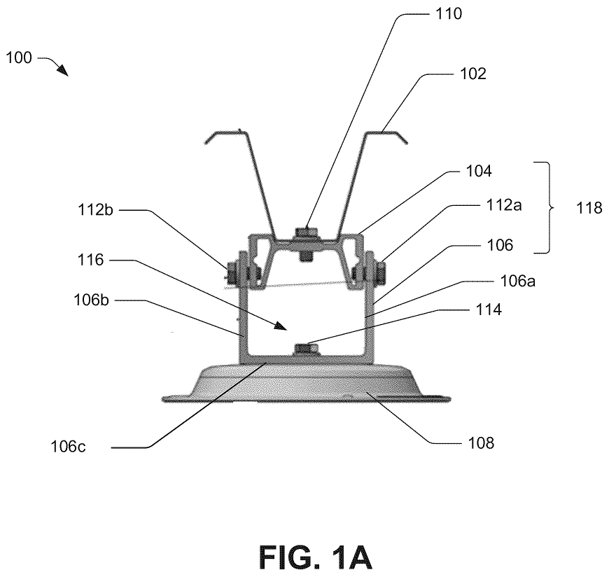

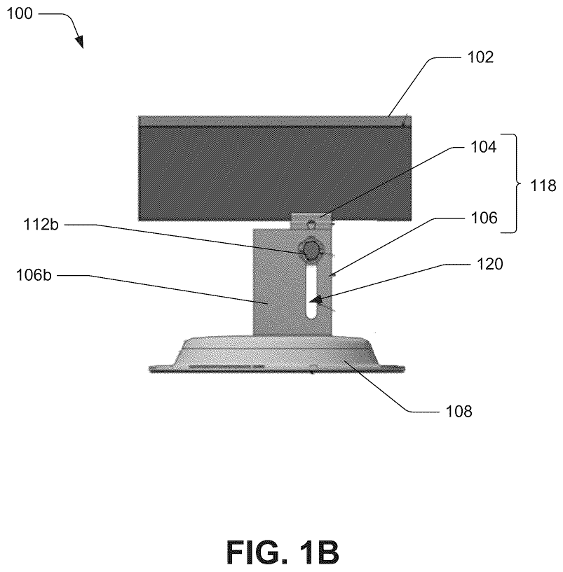

FIGS. 1A and 1B, respectively, illustrate a front view and a side view of an embodiment of a mounting system 100 for mounting a solar panel array system. The mounting system 100 may include a strut channel 102 (e.g., an attachment hat), a holder clamp 104 (e.g., the H-shaped component), a support clamp 106 (e.g., the U-shaped component), and a base 108 (e.g., flat roof attachment).

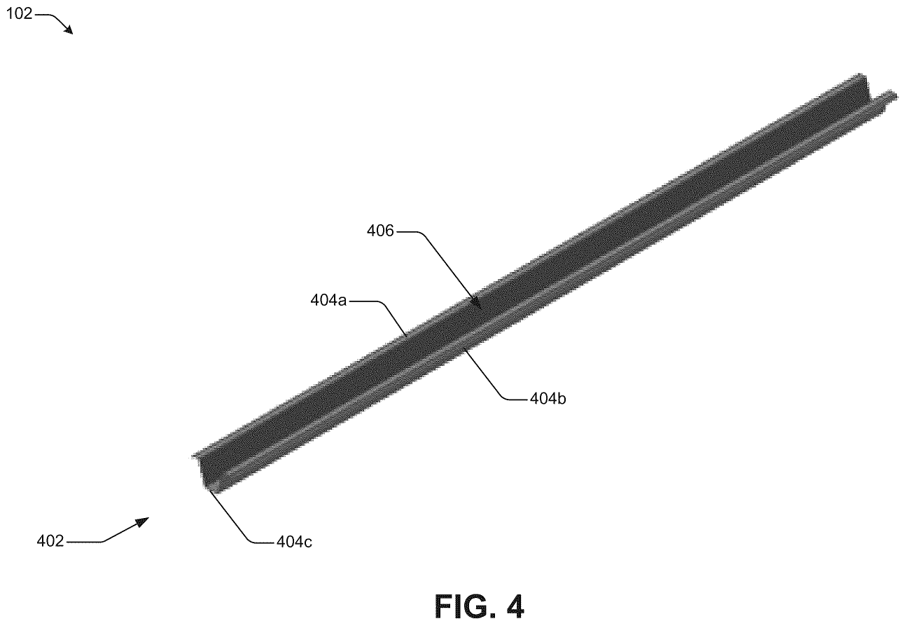

In an embodiment, the strut channel 102 is configured to connect with and/or support the solar panel array system. The strut channel 102 is shaped to facilitate a secure connection between the mounting system 100 and the solar panel array system. The strut channel 102 may include an opening (not visible in FIG. 1A or 1B), or may be punctured, to accommodate a fastener 110, to connect the strut channel 102 to the holder clamp 104. (Additional details of the strut channel 102 are described with reference to FIG. 4).

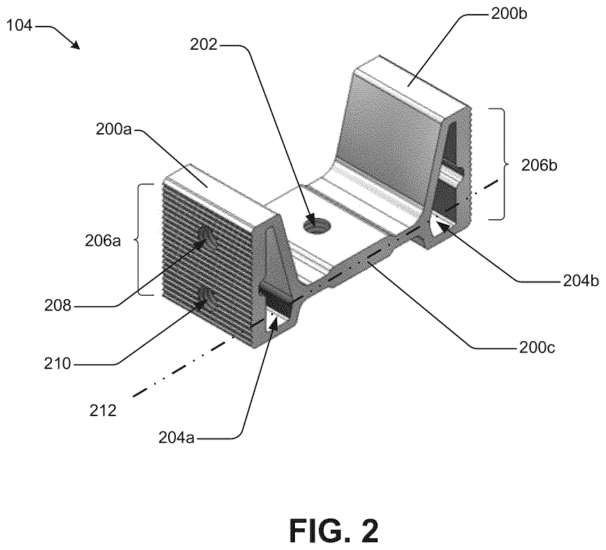

The holder clamp 104 is configured to connect with the strut channel 102. The holder clamp 104 may include a central part and two sidewalls on each side of the central part. The holder clamp 104 is configured to connect with the strut channel 102 via a fastener 110. (Additional details of the holder clamp 104 are described with reference to FIG. 2).

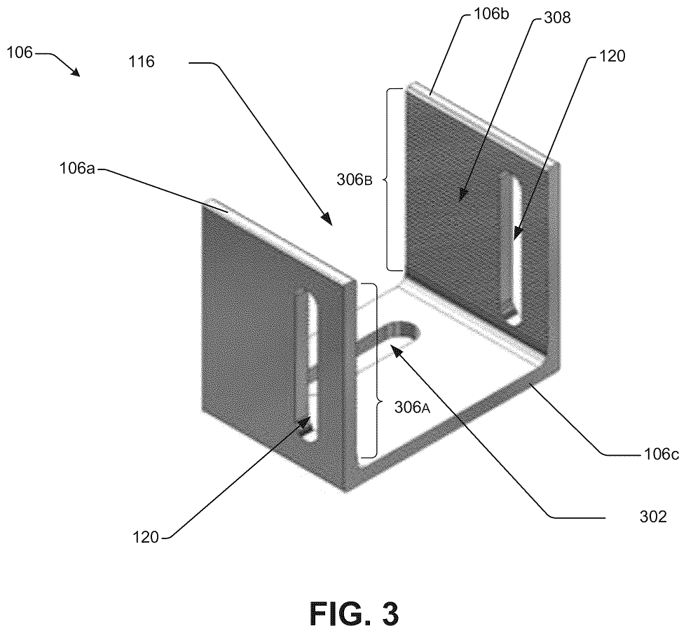

In an embodiment, the support clamp 106 is configured to accommodate and connect to the holder clamp 104. In an embodiment, the support clamp 106 may have a U-shaped structure including two opposing sidewalls 106/106b and a bottom wall 106c. The support clamp 106 and the holder clamp 104 may be connected using adjustment fasteners 112a and 112b. Further, the support clamp 106 is configured to the base 108 via a fastener 114. In an embodiment, the support clamp 106 may include a slot 116 bounded on the sides and the bottom by the two opposing sidewalls 106/106b and the bottom wall 106c, respectively. The slot 116 is sized and configured to receive and accommodate at least a part of the holder clamp 104, allowing the holder clamp 104 to be properly positioned and oriented according to various installation scenarios. For example, the height of the holder clamp 104, with respect to the bottom of the support clamp 106 may be adjusted within the slot 116 of the support clamp 106. Moreover, the holder clamp 104 may be rotated about a horizontal axis within the slot 116 to flip the holder clamp 104 to adjust the height of the cross-member element with respect to support clamp 106. (Additional details of the support clamp 106 are described with reference to FIG. 3).

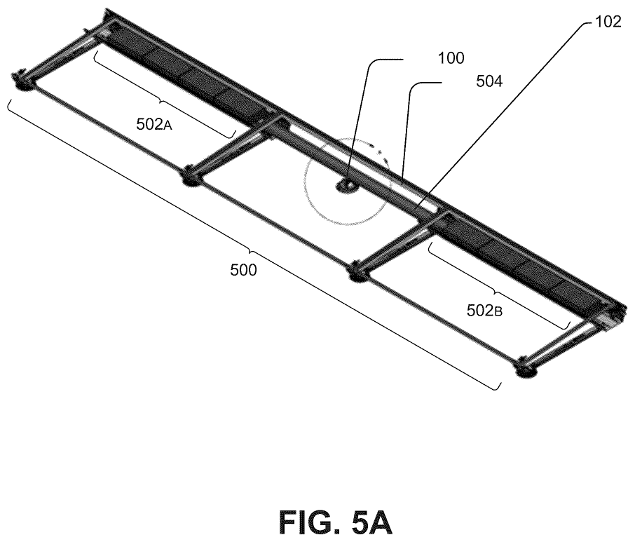

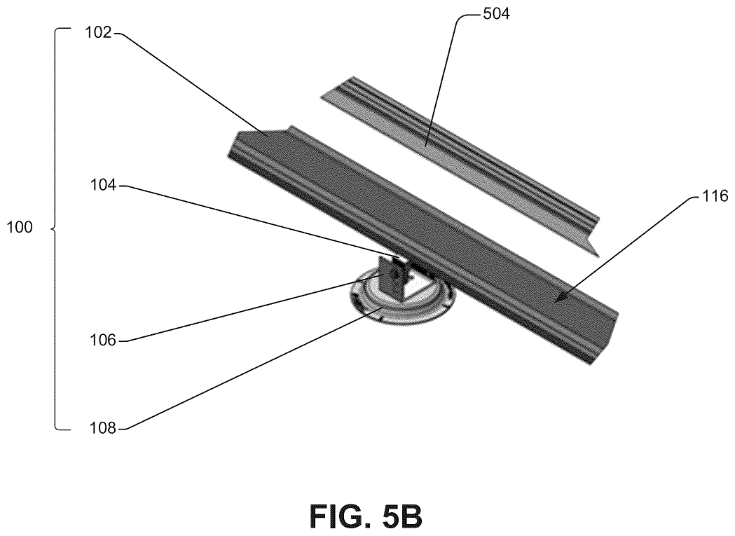

In an embodiment, the base 108 may serve as the foundation of the mounting system 100. In an embodiment, the base may be firmly affixed to base rails (not shown in FIG. 1A). In an embodiment, the base 108 may be positioned adjacent to one or more ballast-supported panels (see FIG. 5B) to enhance the stability and security of the entire mounting system 100. Such placement serves to anchor the solar panel array more effectively, reducing the risk of shifting or displacement under external forces. By distributing the weight and loads more evenly across the base 108, the mounting system 100 may maintain its position more securely, even in challenging conditions.

In an embodiment, the support clamp 106 and holder clamp 104 may be pre-assembled and loosely connected to form a clamp assembly 118, which may simplify the installation process with the base 108 using the fastener 114 to connect the clamp assembly 118 to the base 108. The clamp assembly 118 may be secured together via the adjustment fasteners 112a and 112b, as inserted through openings in the respective sidewalls 106a/106b. (See opening 120 for example in FIG. 1B). This may accelerate installation of the mounting system 100 and may also reduce the potential for errors during installation. The opening 120 may have an elongated shape such that the second adjustment fastener 112b may move up and down within the opening 120, providing a convenient way to adjust the position of the holder clamp 104 with respect the support clamp 106.

During installation, the holder clamp 104 may be adjusted within the slot 116 of the support clamp 106, in terms of height and orientation, to accommodate many roof surface undulations or height variations. Once a desired position is determined, the adjusted position of the holder clamp 104 to the support clamp 106 may be secured by tightening the adjustment fasteners 112a and 112b to a specified torque, such as 10 foot-pound (ft-lbs), for example, to provide a secure and stable connection.

After the clamp assembly 118 is in place, the strut channel 102 may be positioned on top of the clamp assembly 118 and fastened with the fastener 110. The entire mounting system 100 may be further connected to base rails that support the solar panel array, as further detailed in FIGS. 5A and 5B. The mounting process as described may result in a reliable, height-adjustable mounting solution tailored to the needs of the solar panel array installation.

Notably, the fasteners (e.g., fasteners 110/114 and/or the adjustment fasteners 112a/112b) of the mounting system 100 may include but are not limited to bolts, nuts, washers, screws, rivets, anchors, etc. The choice of fasteners may depend on requirements of the installation.

FIG. 2 illustrates a perspective view of the holder clamp 104 depicted in FIGS. 1A and 1B, according to an embodiment. Referring to FIG. 2, the holder clamp 104 may include two sidewalls 200a and 200b, and an intermediate part 200c (e.g., cross member, etc.) disposed therebetween. In an embodiment, the intermediate part 200c and two sidewalls 200a/200b may form an H-shape.

As indicated above, the intermediate part 200c is configured to connect with the support clamp 106. The intermediate part 200c may include an opening 202 sized and shaped to accommodate the fastener 110.

In an embodiment, the sidewalls 200a/200b may include respective internal passages 204a/204b, configured to accommodate at least a part of the adjustment fasteners 112a/112b, respectively. Additionally, the respective external, lateral surfaces of the sidewalls 200a/200b may include textural features, such as lateral serrations 206a/206b. The serrations 206a/206b are configured to enhance friction between the external, lateral surfaces of the sidewalls 200a/200b and the adjacent, internal surfaces of the sidewalls 106a/106b of the support clamp 106. The shape of the serrations may vary to optimize performance, with examples including V-shaped serrations, U-shaped serrations, square-shaped serrations, sawtooth serrations, helical serrations, or other profiles suited to the specific requirements of the application.

The sidewall 200a may also include one or more side openings, such as a first side opening 208 and a second side opening 210, each configured to receive the first adjustment fastener 112a. Likewise, similar openings (not visible) are found on the sidewall 206b.

In implementations, the corresponding symmetrical openings (i.e., 208 and opposite (unseen in FIG. 2)/210 and opposite (unseen in FIG. 2)) on each sidewall 206a/206b work together to connect the holder clamp 104 with the support clamp 106.

The use of different side openings offers flexibility in adjusting the relative position of the holder clamp 104 with respect to the support clamp 106. For instance, when using openings 208 and the adjustment fasteners 112a/112b, the holder clamp 104 may be secured in a relatively lower position with respect to the support clamp 106, accommodating specific height or alignment requirements. However, when using openings 210 and the adjustment fasteners 112a/112b, the holder clamp 104 may be positioned at a higher elevation with respect to the support clamp 106.

Although FIG. 2 illustrates two side openings, it is considered that additional openings may be used. For example, instead of two discrete openings, a single elongated slot may be used, allowing the first adjustment fastener 112a or the second adjustment fastener 112b to move vertically along the slot. Such a configuration may allow continuous adjustment of the holder clamp 104 relative to the support clamp 106, offering flexibility in fine-tuning the mounting system's height and alignment.

Additionally, the intermediate part 200c of the holder clamp 104 may be positioned asymmetric with respect to the sidewalls 106a/106b. For example, the intermediate part 200c is disposed along line 212, as depicted in FIG. 2, which is offset from a central position horizontally across the sidewalls 106a/106b. The vertical asymmetric geometry of the holder clamp 104 allows the strut channel additional height adjustability than would be possible with a symmetric version. Nevertheless, a symmetric version (not shown) is considered. Moreover, by leveraging this asymmetry, the holder clamp 104 may be rotated to a flipped position within the support clamp 106, which provides additional variability in height.

FIG. 3 illustrates a perspective view of the support clamp 106 depicted in FIGS. 1A and 1B, according to an embodiment. As stated above, the support clamp 106 may have a U-shaped structure including the two opposing sidewalls 106/106b and the bottom wall 106c. The bottom part 106c may be configured to connect to the base 108 (or an alternative base unlike the one depicted). The bottom part 106c may include an opening 302 configured to accommodate the fastener 114. In an embodiment, the opening 302, may be a simple circular hole, or may be a horizontally elongated slot, as shown, that extends in a direction between the sidewalls, which facilitates lateral positional adjustment of the support clamp 106 via sliding the fastener 114 within the opening 302.

In an embodiment, the adjustment fasteners 112a/112b may, respectively, be inserted through the openings 120/120 on respective sidewalls 106a/106b. Thus, the adjustment fasteners 112a/112b may move up and down along the respective openings 120 to adjust the position of the holder clamp 104 relative to the support clamp 106, as needed. Though only one opening 120 is shown per sidewall 106a/106b, it is contemplated that more than one may be formed therein for additional positional variation.

Additionally, in an embodiment, the sidewalls 106a/106b may include serrations 306a/306b, respectively, on the internal surfaces of the sidewalls 106a/106b. The serrations 306a/306b may increase friction with the correspondingly located serrations 206a/206b on the external, lateral surfaces of the sidewalls 200a/200b of the holder clamp 104. As with serrations 206a/206b, the shape of the serrations 306a/306b may vary to optimize performance, with examples including V-shaped serrations, U-shaped serrations, square-shaped serrations, sawtooth serrations, helical serrations, or other profiles suited to the specific requirements of the application.

FIG. 4 illustrates a perspective view of the strut channel 102 depicted in FIGS. 1A and 1B. The strut channel 102 may have a shape suitable for facilitating a secure connection between the mounting system 100 and the solar panel array system. In an embodiment, the strut channel 102 may have a cross-section that may be hat-shaped, V-shaped, U-shaped, or otherwise shaped with a channel that opens upward when installed. For example, in an embodiment, the strut channel 102 may be formed with any shape having a bottom portion with opposing sidewalls extending therefrom. The cross-sectional view is considered as the end view of the strut channel 102, when viewed from the direction 402. Such a cross-section may provide structural strength and rigidity, as well as allowing for efficient load distribution across the mounting system 100.

In an embodiment, the strut channel 102 may include a pair of sidewalls 404a and 404b connected to and extending from opposite sides of a bottom wall 404c. In an embodiment, the bottom part 404c may include an opening (not shown in FIG. 4), or may be quickly punctured, to accommodate the fastener 110, which may provide a tight and reliable connection between the strut channel 102 and the holder clamp 104.

The bottom part 404c and two side parts 404a and 404b of the strut channel 102 may define a channel 406 therebetween.

The shapes and dimensions of each respective component described above (i.e., strut channel 102, holder clamp 104, holder strut 106, and depicted in the figures, are presented for exemplary purposes and other shapes are considered. That is, alternative shapes and configurations may be utilized for the features and components described above, which may be suitable to effectively perform the respective functions within the mounting system 100. Moreover, the materials of the features may vary from metal, to plastic, to composites, etc. so long as the chosen material is satisfactory for the required functional characteristics of strength, rigidity, etc.

FIG. 5A illustrates a perspective view of an example solar panel array system 500 installed with a mounting system 100 positioned between a first and second set of ballast support rows 502a/502b. The strut channel 102 connects the combination of the holder clamp 104, support clamp 106, and base 108 (e.g., of the mounting system 100) to the base rails of the solar panel array system 500. The holder clamp 104 connects with the strut channel 102 to allow for necessary adjustments during installation. The support clamp 106 offers structural reinforcement and assists in the height adjustability, supporting loads with the base 108. Moreover, the base 108 anchors the entire mounting system to a surface.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A mounting system comprising:
a strut channel;
a holder clamp configured to connect with the strut channel; and
a support clamp configured to secure the holder clamp,
wherein the holder clamp is movable in a vertical direction within the support clamp.

2. The mounting system according to claim 1, further comprising a base that is connectable with a lower surface of the support clamp.

3. The mounting system according to claim 1, wherein the strut channel has a pair of sidewalls and a bottom wall connected between the pair of sidewalls at respective lower ends thereof.

4. The mounting system according to claim 1, further comprising a first adjustment fastener and a second adjustment fastener respectively receivable by opposing sidewalls of the support clamp to secure the holder clamp within the support clamp.

5. The mounting system according to claim 4, wherein the holder clamp includes:
a first sidewall having a first side opening and a second side opening sized to accommodate the first adjustment fastener; and
a second sidewall having a third side opening and a fourth side opening sized to accommodate the second adjustment fastener.

6. The mounting system according to claim 5, wherein
the first sidewall further has a first internal passage sized to accommodate at least a part of the first adjustment fastener; and
the second sidewall further has a second internal passage sized to accommodate at least a part of the second adjustment fastener.

7. The mounting system according to claim 5, wherein the first sidewall and the second sidewall each include serrations on respective opposing external surfaces.

8. The mounting system according to claim 1, wherein the support clamp is U-shaped.

9. The mounting system, according to claim 1, wherein the holder clamp is held within the support clamp.

10. The mounting system according to claim 1, wherein the support clamp and the holder clamp are pre-assembled as a clamp assembly.

11. A mounting system comprising:
a strut channel;
a clamp assembly attachable to the strut channel at a lower surface thereof, the clamp assembly including:
a holder clamp configured to connect with the strut channel; and
a support clamp securing the holder clamp adjustably within a pair of opposing walls; and
a base that is connectable to a lower surface of the clamp assembly.

12. The mounting system according to claim 11, further comprising a first adjustment fastener and a second adjustment fastener to respectively connect the holder clamp with the support clamp on the pair of the opposing walls.

13. The mounting system according to claim 11, wherein the holder clamp includes serrations on opposing external surfaces thereof.

14. The mounting system according to claim 11, wherein the support clamp includes serrations on opposing internal surfaces thereof.

15. The mounting system according to claim 13, wherein the holder clamp includes an H-shape having opposing sidewalls connected by an intermediate wall.

16. The mounting system according to claim 15, wherein the intermediate wall is offset from a center line through the opposing sidewalls of the holder clamp.

17. The mounting system according to claim 11, wherein the holder clamp is rotatable about a horizontal axis in the support clamp.

18. The mounting system according to claim 16, wherein a slot is defined between the pair of the opposing walls of the support clamp, and
wherein the holder clamp is rotatable within the slot.

19. The mounting system according to claim 11, the strut channel is U-shaped.

20. A mounting system comprising:
a strut channel configured to support a solar panel module;
a holder clamp that is connectable with the strut channel;
a support clamp having a slot sized to support the holder clamp therein; and
a base having an opening to receive a fastener to connect to the support clamp,
wherein the holder clamp is configured to be adjustable within the slot positionally and orientationally.
